(19) United States
(12) Patent Application Publication
(10) Pub. No.: US 2022/0019236 A1
(43) Pub. Date: Jan. 20, 2022

(54) SYSTEM AND A METHOD FOR ORCHESTRATING MULTIPLE MOBILE ROBOTS

(71) Applicant: INDOOR ROBOTICS LTD., Ramat-gan (IL)

(72) Inventors: DORON BEN-DAVID, RAMAT-GAN (IL); AMIT MORAN, TEL-AVIV (IL)

(21) Appl. No.: 16/930,423

(22) Filed: Jul. 16, 2020

(51) Int. Cl. G05D 1/02; B25J 9/00; B25J 5/00; B60L 58/10; G05B 19/4155

(52) U.S. Cl. CPC G05D 1/0291; B25J 9/0003; B25J 5/00; G05D 1/0231; G05B 2219/40233; G05D 1/0255; B60L 58/10; G05B 19/4155; B60L 2200/00; G05D 1/0257

(57) ABSTRACT

A computerized system including multiple mobile robots, each mobile robot has a set of skills, multiple dock stations, each of the multiple dock stations is configured to dock one or more of the multiple mobile robots, an interface for receiving a mission to be executed by at least one of the multiple mobile robots, a processor communicating with the multiple mobile robots, said processor determines which of the multiple mobile robots is assigned to perform the mission based on a set of values that matches the mission.

### FIELD

The present invention relates to a robotics system comprising multiple mobile robots.

### BACKGROUND

Use of robots increases to facilitate life, in addition to facilitate commercial activities, such as manufacture, medical operations, customer service and the like. Robots clean our houses, deliver goods from one place to another, function as mobile sensor, provide communication to lonely people and have many more functions. These robots are equipped with an actuation mechanism, such as a motor, a power source, mostly a rechargeable battery, and an operating module that performs the task required by the robot. Such operating module may be a cleaning module such as a vacuum cleaner, may be a camera in case the robot is a surveillance or monitoring robot, may be a processor, speaker and audio sensor for communicating with another person and others. The robot may include a wireless communication module for exchanging information with another electronic device.

In many cases, there are several robots located in a specified area, such as a factory, hospital, office building, stadium and the like. These robots may perform routine tasks, such as robot #2 may perform the task defined “cleaning room #103 between 22:00 and 22:15” every day.

### SUMMARY

The subject matter discloses a computerized system, comprising multiple mobile robots, each mobile robot has a set of skills, such that the multiple mobile robots have at least two different sets of skills; multiple dock stations, each of the multiple dock stations is configured to dock one or more of the multiple mobile robots; an interface for receiving a mission to be executed by at least one of the multiple mobile robots; a processor communicating with the multiple mobile robots, said processor determines which of the multiple mobile robots is assigned to perform the mission based on a set of values that matches the mission.

In some cases, the interface comprises a sensor unit for collecting information, and wherein the processor identifies the mission based on the information collected by the sensor unit.

In some cases, the computerized system further comprising a location memory for storing a location of the multiple mobile robots over time, wherein the processor is coupled to the location memory, wherein the mission is assigned a mission location, wherein the processor computes a distance between the mission location and locations of mobile robots having the set of skills that matches the mission.

In some cases, the processor determines which of the multiple mobile robots is assigned to perform the mission in a distributed manner using processing resources of at least two of the multiple mobile robots. In some cases, the processor is a central processor located in one of the multiple mobile robots. In some cases, the processor is a central processor located in a controlling device communicating with the multiple mobile robots. In some cases, the computerized system further comprising a mission history memory for storing information concerning prior missions performed by the multiple mobile robots.

In some cases, the computerized system further comprising a battery memory for storing information concerning the battery status the multiple mobile robots, wherein the processor determines whether or not a specific mobile robot of the multiple mobile robots is capable to perform the mission based on battery consumption estimated to be consumed during the mission for the specific mobile robot and the battery status stored in the battery memory.

In some cases, the processor predicting additional missions to be performed by the multiple mobile robots during a time period overlapping with the mission based on prior missions' experience, wherein the processor selecting a first group of mobile robots of the multiple mobile robots to perform the additional missions; wherein the one or more mobile robots assigned to perform the mission are excluded from the first group of mobile robots.

In some cases, the mission requires docking one or more mobile robots to a dock station, wherein the dock station is selected based on the location of the mission, and the processor verifying that the assigned mobile robot matches the selected dock station. In some cases, the computerized system further comprises a dock station memory coupled to the processor, said dock station memory storing properties of the multiple dock station, wherein a dock station is selected if properties of the dock station fit the mission. In some cases, the properties comprise network connectivity, materials contained in the dock station, processing capabilities of a dock station processor, size of the dock station and a combination thereof. In some cases, the skills included in the set of skills comprise capturing images, cleaning, dispensing a material, carrying objects and a combination thereof.

### BRIEF DESCRIPTION OF THE DRAWINGS

The invention may be more clearly understood upon reading of the following detailed description of non-limiting exemplary embodiments thereof, with reference to the following drawings, in which:

FIG. 1 disclose a computerized environment having multiple mobile robots and multiple dock stations, according to exemplary embodiments of the subject matter.

FIG. 2 shows schematic components of a mobile robot, according to exemplary embodiments of the disclosed subject matter.

FIG. 3 shows a table showing a set of skills for each mobile robot of a multiple robots included in a computerized system, according to exemplary embodiments of the disclosed subject matter.

FIG. 4 shows a table showing additional information associated with each mobile robot of a multiple robots included in a computerized system, according to exemplary embodiments of the disclosed subject matter.

FIG. 5 shows a method for selecting one or more mobile robots from a group of multiple robots to perform a mission, according to exemplary embodiments of the disclosed subject matter.

FIG. 6 shows a method for identifying a mission to be performed by one or more mobile robots from a group of multiple robots, according to exemplary embodiments of the disclosed subject matter.

FIG. 7 shows a method for selecting one or more mobile robots to perform a mission in a distributed manner, according to exemplary embodiments of the disclosed subject matter.

FIG. 8 shows a method for selecting one or more mobile robots to perform a mission based on robots' location, according to exemplary embodiments of the disclosed subject matter.

FIG. 9 shows a method for selecting one or more mobile robots to perform a mission based on battery capabilities, according to exemplary embodiments of the disclosed subject matter.

FIG. 10 shows a method for generating a mission based on information collected by a sensor, according to exemplary embodiments of the disclosed subject matter.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

Illustrative embodiments of the invention are described below. In the interest of clarity, not all features/components of an actual implementation are necessarily described.

The subject matter in the present invention discloses a system and method for operating multiple mobile robots to execute missions. The multiple mobile robots may be coupled to dock stations located in an area. The method comprises selecting one or more mobile robots to perform a mission based on a number of constraints, considerations and rules.

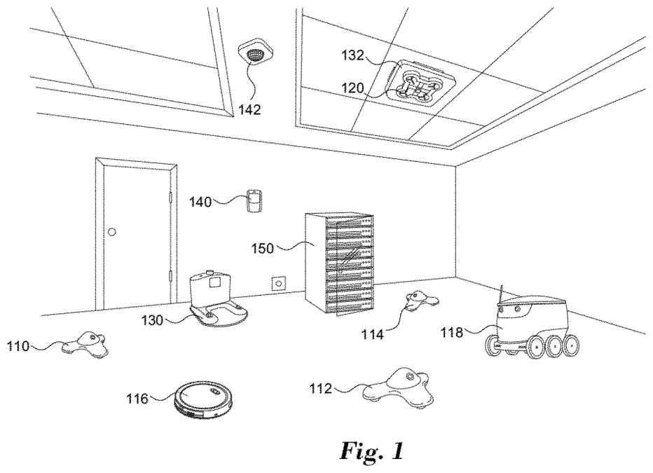

FIG. 1 disclose a computerized environment having multiple mobile robots and multiple dock stations, according to exemplary embodiments of the subject matter. The mobile robots 110, 112, 114, 116, 118 and 120 comprise an actuation mechanism enabling independent movement of the mobile robots. In other words, the robots' movement does not require a third party moving the robots from one place to another. The term “robot” as used below is defined as a “mobile robot” capable of moving independently. The mobile robots 110, 112, 114, 116, 118 and 120 also include a power source, for example connection to the electricity grid, a battery, a solar panel and charger and the like. The battery may be charged by a dock station, selected from dock stations 130, 132.

Each dock station of dock stations 130, 132 may enable one or more of the mobile robots 110, 112, 114, 116, 118 and 120 to dock thereto. Docking may provide the mobile robots 110, 112, 114, 116, 118 and 120 with electrical voltage, in case the dock stations 130, 132 are coupled to a power source. The dock stations 130, 132 may have communication connectivity, such as a cellular modem or internet gateway, enabling the dock stations 130, 132 to transfer information from the mobile robots 110, 112, 114, 116, 118 and 120 to a remote device such as a server or a central control device 150. The dock stations 130, 132 may be secured to a wall, a floor, the ceiling, or to an object in the area, such as a table. The dock stations 130, 132 may be non-secured dock-stations, for example a mobile robot with a big battery or an extension cord connected to the mobile robot may function as a dock station, charging another robot.

The central control device 150 may be a computer, such as a laptop, personal computer, server, tablet computer and the like. The central control device 150 may store a set of rules enabling to decide which of the mobile robots to be sent to perform a mission. The central control device 150 may comprise an input unit enabling users to input missions therein. The input unit may be used to input constraints, such as maximal number of missions per time unit. The central control device 150 may be coupled to at least a portion of the mobile robots 110, 112, 114, 116, 118 and 120, for example in order to send commands to the robots, to receive a location of the robots, and additional information, such as technical failure of a component in the robot, battery status, mission status and the like. In some cases, the computerized environment lacks the central control device 150, and one or more of the mobile robots 110, 112, 114, 116, 118 and 120 perform the tasks described with regard to the central control device 150.

The computerized environment may also comprise a sensor unit comprising one or more sensors 140, 142. The sensors 140, 142 may be image sensors for capturing images, temperature sensor, humidity sensor, audio sensor, LIDAR sensor and the like. The sensors 140, 142 of the sensor unit may be secured to a certain object, such as a wall, shelf, table, ceiling, floor and the like. The sensors 140, 142 of the sensor unit may collect information at a sampling rate and send the collected information to the central control device 150. The sensors 140, 142 of the sensor unit may have a processing unit which determines whether or not to send the collected information to the remote device, such as to one or more of the mobile robots 110, 112, 114, 116, 118 and 120 or the central control device 150.

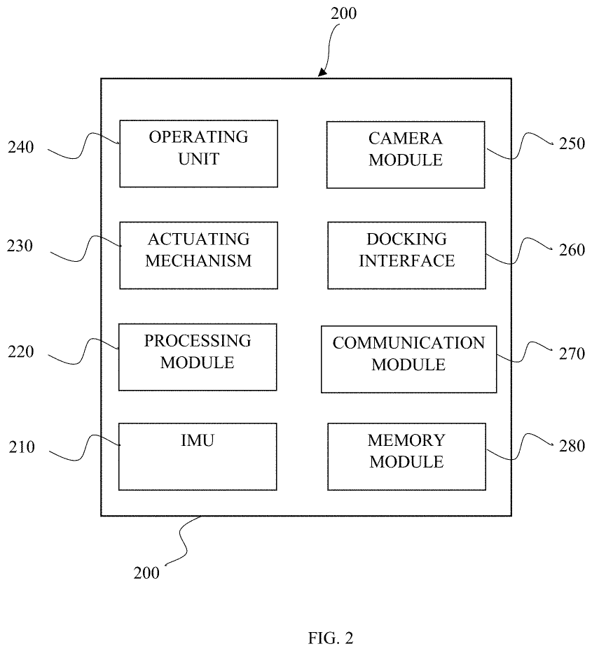

FIG. 2 shows schematic components of a mobile robot, according to exemplary embodiments of the disclosed subject matter. The mobile robot 200 comprises an operating unit 240 dedicated to perform a mission. The operating unit 240 may comprise one or more arms or another carrying member for carrying an item. The carrying member may be a magnetic plate for securing a metallic object. The operating unit 240 may comprise a container for containing a material, for example water, paint, sanitation material, perfume, beverages, a cleaning material, in case the mission is to provide a material to a certain place or person. The operating unit 240 may be a sensor for sensing information in a certain location, said sensor may be an image sensor, audio sensor, temperature sensor, odor sensor, sensor for detecting presence of a material and the like.

The mobile robot 200 comprises an actuation mechanism 230 for moving the mobile robot 200 from one place to another. The actuation mechanism 230 may comprise a motor, an actuator and any mechanism configured to maneuver a physical member. The actuation mechanism 230 may comprise a rotor of some sort, enabling the mobile robot 200 to fly. The actuation mechanism 230 is coupled to a power source, such as a battery or a renewable energy member, such as a solar panel in case the area comprises or is adjacent to an outdoor area accessible to the mobile robot 200. The actuation mechanism 230 may move the mobile robot 200 in two or three dimensions.

The mobile robot 200 may also comprise an inertial measurement unit (IMU) 210 configured to measure the robot's linear acceleration and angular velocities. The measurements collected by the IMU 210 may be transmitted to a processing module 220 configured to process the measurements. The IMU 210 may comprise one or more sensors, such as an accelerator, a gyroscope, a compass or magnetometer, a barometer and any the like.

The processing module 220 is configured to control the missions, and other actions, performed by the mobile robot 200. Thus, the processing module 220 is coupled to the actuation mechanism 230 configured to move the mobile robot 200. Such coupling may be via an electrical channel or cable, wireless communication, magnetic-based communication, optical fibers and the like. The processing module 220 may send a command to the actuation mechanism 230 to move to a certain location associated with a mission. The command may include instructions as to how to move to the certain location. The processing module 220 as defined herein may be a processor, controller, microcontroller and the like. The processing module 220 may be coupled to a communication module 270 via which the missions are received at the mobile robot 200. The communication module 270 may be configured to receive wireless signals, such as RF, Bluetooth, Wi-Fi and the like. The mobile robot 200 may also comprise a camera module 250 including one or more cameras for capturing images and/or videos.

The mobile robot 200 may comprise a memory module 280 configured to store information. For example, the memory module 280 may store prior locations of the mobile robot 200, battery status of the mobile robot 200, mission history of the mobile robot 200 and the like. The processing module 220 may sample one or more memory addresses of the memory module 280 to identify alerts to be sent to a remote device. Such alert may be low battery, failure of the operation unit 240 and the like. Such alert may be sent via the communication module 270. Such remote device may be a dock station or a server, such as a web server.

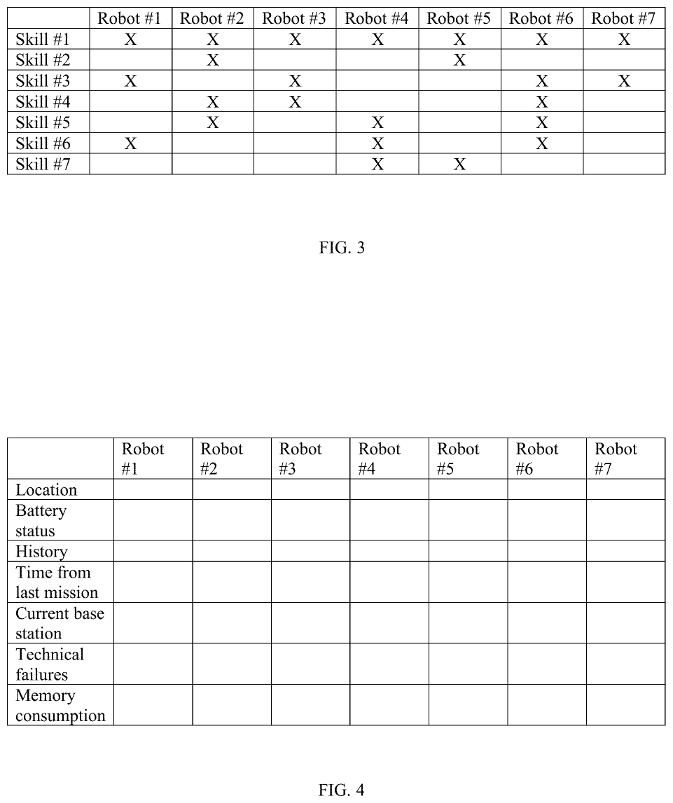

FIG. 3 shows a table showing a set of skills for each mobile robot of a multiple robots included in a computerized system, according to exemplary embodiments of the disclosed subject matter. The table shows a list of optional skills, and which mobile robots of the multiple robots included in the system has which skills. The number of mobile robots in the system may change over time, for example in case a mobile robot is added to the system, removed for maintenance, assigned to another system and the like. The skills may include at least the following skills: surveillance, monitoring, movement range (based for example on battery size), presence of materials in a container carried by the mobile robot, data processing capabilities, image processing capabilities, data communication capabilities, cleaning unit, output of audio signals, presence of a display device at the mobile robot or carried by the mobile robot, and a combination of the above.

The missions performed by the multiple mobile robots require one or more of the skills listed in the table. For example, a cleaning mission may require a skill #3, therefore only mobile robots #1, #3, #6 and #7 may be assigned to perform the cleaning mission. Similarly, mobile robot #5 can perform missions that require skills #1, #2 and #7. The number of skills may vary from one system to another. The skills and the skills' definitions may change based on a command from a user, or based on an event, such as temperature measurement, failure to perform a mission and the like. The skills required to perform the mission may be stored in a memory accessible to the processor, or be computed by the processor.

FIG. 4 shows a table showing additional information associated with each mobile robot of a multiple robots included in a computerized system, according to exemplary embodiments of the disclosed subject matter. The processor of the system assigns one or more mobile robots of the multiple mobile robots to perform the mission based on the skills required to perform the mission and additional information accessible to the processor. The additional information may include the mobile robot's location, mobile robot's battery status, information concerning prior missions performed by the mobile robots, prior dock stations used by each mobile robot, prior docking times by each mobile robot, size of each mobile robot, quantity of material carried by the mobile robot, alert and failures associated with components of the mobile robot, and the like.

The processor utilizes the skill set of the mobile robots, and the additional information, in order to determine the mobile robot to be assigned to perform the mission. The processor may first filter a group defined as relevant mobile robots from the multiple mobile robots based on the skill set of the mobile robots and whether or not the skill set matches the mission. Then, the processor selects one or more mobile robots from the relevant mobile robots to perform the mission. The selection may be performed based on information related to the mission, for example estimated time consumed by the mobile robot to perform the mission, location to perform the mission, post tasks to be performed by the mobile robot after performing the mission, and the like. The selection may be performed based on the additional information associated with the mobile robots, as elaborated above, and in the table of FIG. 4.

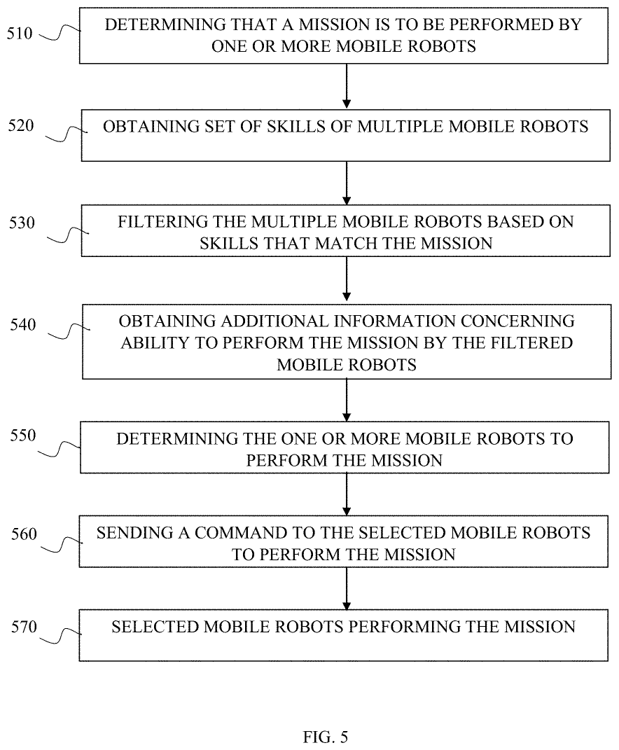

FIG. 5 shows a method for selecting one or more mobile robots from a group of multiple robots to perform a mission, according to exemplary embodiments of the disclosed subject matter.

Step 510 discloses determining that a mission is to be performed by one or more movable robots. Such determination may be based on a user inputting information into a computerized device coupled to the system that implements the method. Such determination may result from an event, such as measurement collected by a sensor included in the sensor unit of the system, a sensor carried by one of the mobile robots included in the system, and the like. The mission is defined by one or more mission properties, such as mission type, mission location, mission start time, mission duration, number of robots used to perform the mission, technical requirements for performing the mission and the like.

Step 520 discloses obtaining set of skills of multiple movable robots. The set of skills may be stored in a memory device accessible to the processor, such as a memory device of the mobile robots, or a central control device communicating with the multiple mobile robots. The set of skills may result from physical equipment installed in or carried by the mobile robots. The set of skills may result from computational resources, such as a set of algorithms or audio files stored in a memory of the mobile robot. The set of skills may include a list as desired by a person skilled in the art. The list may be updated frequently, or based on an event, such as download of files into a mobile robot's memory. The set of skills may include at least the following skills: surveillance, monitoring, movement range (based for example on battery size), presence of materials in a container carried by the mobile robot, data processing capabilities, image processing capabilities, data communication capabilities, cleaning unit, output of audio signals, presence of a display device at the mobile robot or carried by the mobile robot, and a combination of the above.

Step 530 discloses filtering the multiple movable robots based on skills that match the mission. This step is optional, for example in case all the mobile robots have the same skill set. Filtering is performed in order to fit the skill set of the mobile robots to the skill set required for the mission. The skill set required for the mission may be predefined or defined by the processor. For example, in case the mission requires cleaning and outputting audio signals, the processor may assign a single mobile robot having both skills, or two robots, one capable or cleaning and the other capable of outputting audio signals. The robots unable to output audio signals nor cleaning will thus be filtered and will not be chosen to perform the mission.

Step 540 discloses obtaining additional information concerning ability to perform the mission by the filtered movable robots. The additional information may be mission-related, robot-related or general. Mission-related additional information may be mission type, mission location, mission start time, mission duration, number of robots used to perform the mission, technical requirements for performing the mission and the like. Robot-related additional information may include mobile robot's location, mobile robot's battery status, information concerning prior missions performed by the mobile robots, prior dock stations used by each mobile robot, prior docking times by each mobile robot, size of each mobile robot, quantity of material carried by the mobile robot, alert and failures associated with components of the mobile robot, and the like. General information may be weather, time in the day, additional missions scheduled for the system, and the like.

Step 550 discloses determining the one or more movable robots to perform the mission. The determination may include assigning a value to at least some of the multiple mobile robots. The value indicates the level in which a specific mobile robot is fit to perform the mission. The value is computed by the processor based on at least one additional information. In some cases, the value is computed based on at least one robot-related additional information and at least one mission-related additional information. In some exemplary cases, determining the one or more movable robots comprises computing a distance between a current location of the mobile robot and a location of the mission. In some cases, the processor computes whether the battery status of a mobile robot is sufficient to perform the mission, for example based on mission properties and the computed distance. For example, in case the battery is 25% full, travel to the mission location is expected to consume 7% of the battery and performing the mission is expected to consume 19% of the battery. This way, the specific mobile robot is incapable to perform the mission.

Step 560 discloses sending a command to the selected movable robots to perform the mission. the command may be sent over the internet. The command may be sent to a dock station in which the mobile robot is currently docking. The command may be sent via an RF or a Bluetooth protocol.

Step 570 discloses selected movable robots performing the mission. Performing the mission may comprise the selected movable robots moving to the mission location at the mission start time. After the mission is complete, the mobile robots may report to the processor that the mission is complete. The processor may then send the mobile robots to a dock station. The dock station may be selected based on a distance to the mobile robots, whether or not the dock station mechanically fits the mobile robot, and additional properties.

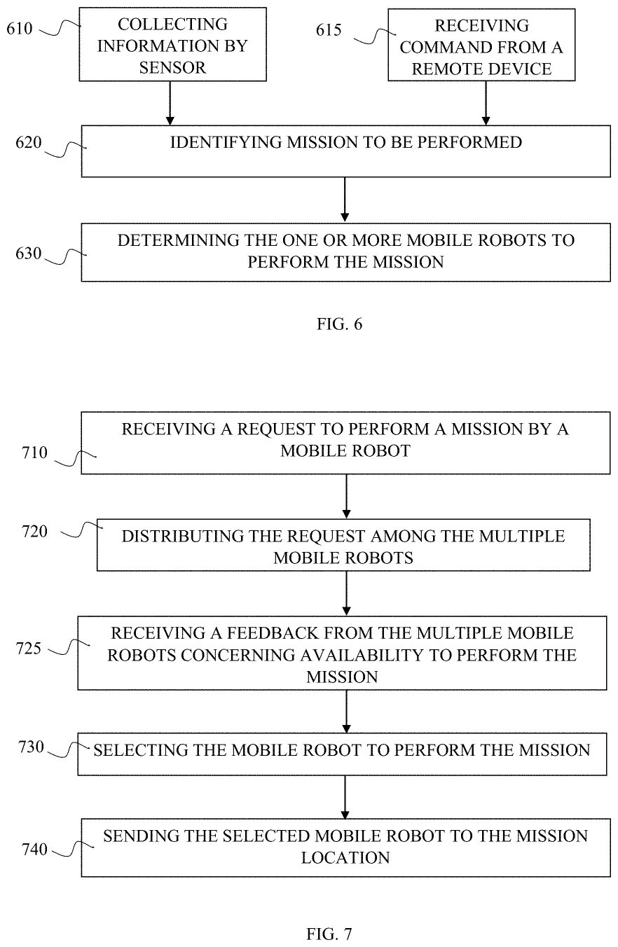

FIG. 6 shows a method for identifying a mission to be performed by one or more mobile robots from a group of multiple robots, according to exemplary embodiments of the disclosed subject matter.

Step 610 discloses collecting information by a sensor. The sensor may be one or more image sensors for capturing images, temperature sensor, humidity sensor, audio sensor, odor sensor, sensor for detecting presence of a material and a combination thereof. The collected information may be sent to the processor. In some cases, the information is sent to the processor only in case the value measured exceeds a threshold, or matches a condition.

Step 615 discloses receiving command from a remote device. Such command may be transferred over the internet, over a wired cable or over a wireless network. The command may specify the mission or conditions from which the processor can generate the mission, such as noise, smell, change in patterns and the like.

Step 620 discloses identifying the mission to be performed based on the information, whether the information is from the sensors, from a user, from a remote device, or a combination thereof. The mission is identified by at least some of the following data fields: mission type, mission requirement, mission start time, mission location, mission duration and the like.

Step 630 discloses determining the one or more mobile robots to perform the mission. Determination of the mobile robots is elaborated above, with regard to step 550.

FIG. 7 shows a method for selecting one or more mobile robots to perform a mission in a distributed manner, according to exemplary embodiments of the disclosed subject matter.

Step 710 discloses receiving a request to perform a mission by a mobile robot. The request may be generated by a person, by one of the mobile robots, by a sensor, by a remote device communicating with one of the mobile robots and the like. The request may contain mission information, such as mission type, mission location, and additional mission information elaborated above.

Step 720 discloses distributing the request among the multiple mobile robots. The request and request information are sent to the multiple mobile robots, for example over a wireless channel. The distribution may end when a sufficient number of mobile robots receive the request and request information, after a predefined timeout event occurs and in response to another event desired by a person skilled in the art.

Step 725 discloses receiving a feedback from the multiple mobile robots concerning availability to perform the mission. The multiple mobile robots may perform computations locally, using a processor inside the mobile robot. A specific mobile robot may determine whether or not the specific mobile robot is available to perform the mission. Such determination may be done based on distance to mission location, other missions scheduled to the specific mobile robot, skills the specific mobile robot has and the like. The feedback may be received only from the mobile robots that are available for performing the mission.

Step 730 discloses selecting the mobile robot to perform the mission. The selection may be an output of a function. The function may be computed by a single mobile robot. The function may be computed by multiple mobile robots, to verify correctness and prevent a case in which malicious attack on one of the mobile robots changes the selection of the mobile robot having the best match to perform the mission.

Step 740 discloses sending the selected mobile robot to the mission location.

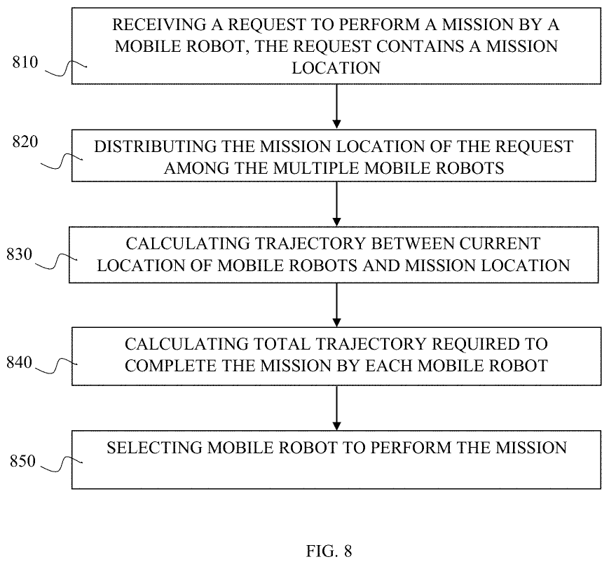

FIG. 8 shows a method for selecting one or more mobile robots to perform a mission based on robots' location, according to exemplary embodiments of the disclosed subject matter.

Step 810 discloses receiving a request to perform a mission by a mobile robot, the request contains a mission location. The request may be generated by a person, by a sensor, by a remote device communicating with one of the mobile robots and the like. The request may contain mission information, such as mission type, mission location, and additional mission information elaborated above.

Step 820 discloses distributing the mission location of the request among the multiple mobile robots. The request and request information are sent to the multiple mobile robots, for example over a wireless channel. The distribution may end when a sufficient number of mobile robots receive the request and request information, or after timeout of the process.

Step 830 discloses calculating trajectory between current location of mobile robots and mission location. The robot's current location may be received via GPS, or using indoor localization over maps of an area, signals from beacons, while sampling the signals periodically to remain within a limited accuracy range. Such calculation may be executed locally, by a specific mobile robot. Such calculation may be executed by a central control device that receives the current location from the mobile robot. The trajectory may also consider movement of the mobile robot. For example, in case the mobile robot currently moves away from the mission location, the calculation of the trajectory may also consider the way away from the mission location before the mobile robot can change its movement direction.

Step 840 discloses calculating total trajectory required to complete the mission by each mobile robot. The total trajectory may comprise the trajectory between the robot's current location to the mission location plus the trajectory required to perform the mission, plus the trajectory required between the location in which the mission ends to a dock station that fits the mobile robot and is available.

Step 850 discloses selecting mobile robot to perform the mission. The selection may filter the mobile robots having a trajectory between current location of mobile robots and mission location that satisfies a condition or threshold. The selection may filter the mobile robots having a total trajectory that satisfies a condition or threshold. In some exemplary cases, the selection may be dictated by the minimal total trajectory among the multiple mobile robots.

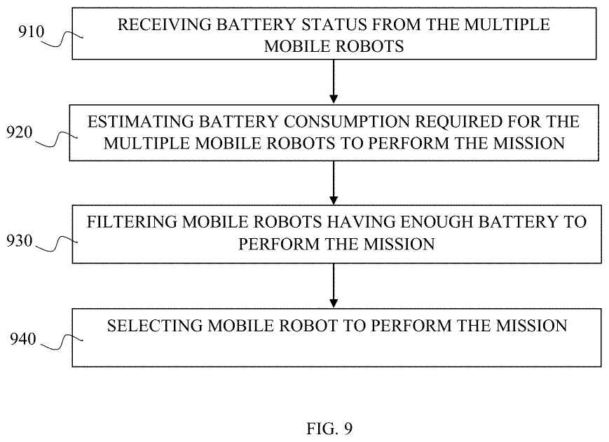

FIG. 9 shows a method for selecting one or more mobile robots to perform a mission based on battery capabilities, according to exemplary embodiments of the disclosed subject matter.

Step 910 discloses receiving battery status from the multiple mobile robots. The battery status may be represented as a percentage of remaining voltage from the entire battery, as voltage or amperes, and the like. The battery status may be sent from the mobile robot's transmitter or from another device coupled to the mobile device, such as the dock station. The battery status may be sent periodically, for example once every 40 seconds, or in response to an event, such as end of mission, reaching a dock station, reaching less than 10 percent of the battery remaining and the like.

Step 920 discloses estimating battery consumption required for the multiple mobile robots to perform the mission. The battery consumption may vary based on a known battery consumption for each mobile robot. One robot may require 10 milli amperes hour (mAh) to perform a mission, while another robot may require 120 milli amperes hour to perform the same mission. The estimation may be computed by a central control device, locally for each robot, or in a distributed manner, by multiple robots cooperating.

Step 930 discloses filtering mobile robots having enough battery to perform the mission. The mission is estimated to require a total battery, composed of the battery consumed to reach the mission location, battery for performing the mission and battery to reach a dock station after the mission. The total battery may be 35 percent from a standard battery of the mobile robots. Hence, robots having less than 40 percent of the battery remaining may not be considered when selecting the mobile robot to perform the mission.

Step 940 discloses selecting mobile robot to perform the mission. The selection may be dictated by the minimal total battery consumption among the multiple mobile robots.

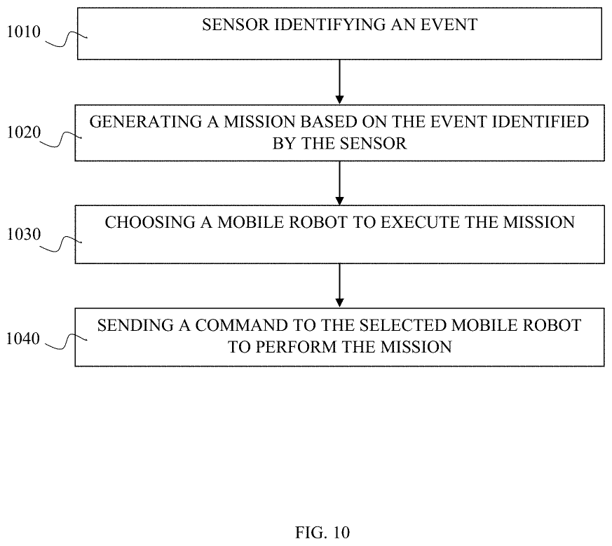

FIG. 10 shows a method for generating a mission based on information collected by a sensor, according to exemplary embodiments of the disclosed subject matter.

Step 1010 discloses a sensor identifying an event. The event may be identified as exceeding from a standard range. The event may be collection of information that represents different noise, odor, volume, image than standard.

Step 1020 discloses generating a mission based on the event identified by the sensor. The mission may be generated locally by the sensor, generated by a central control device, or by one or more robots. The mission is defined by one or more mission properties, such as mission type, mission location and the like.

Step 1030 discloses selecting a mobile robot to execute the mission. The selection may be performed locally by the sensor, generated by a central control device, or by one or more robots. The selection may consider a status of the mobile robots, skills of the robots, additional missions and the like.

Step 1040 discloses sending a command to the selected mobile robot to perform the mission. The command may be sent over a wireless medium, such as a cellular network, via Bluetooth, Wi-Fi and the like. The command may be sent over a wired cable.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

What is claimed is:

1. A computerized system, comprising:
multiple mobile robots, each mobile robot has a set of skills;
multiple dock stations, each of the multiple dock stations is configured to dock one or more of the multiple mobile robots;
an interface for receiving a mission to be executed by at least one of the multiple mobile robots;
a processor communicating with the multiple mobile robots, said processor determines which of the multiple mobile robots is assigned to perform the mission based on a set of values that matches the mission.

2. The computerized system of claim 1, wherein the interface comprises a sensor unit for collecting information, and wherein the processor identifies the mission based on the information collected by the sensor unit.

3. The computerized system of claim 1, further comprising a location memory for storing a location of the multiple mobile robots over time, wherein the processor is coupled to the location memory, wherein the mission is assigned a mission location, wherein the processor computes a distance between the mission location and locations of mobile robots having the set of skills that matches the mission.

4. The computerized system of claim 1, wherein the processor determines which of the multiple mobile robots is assigned to perform the mission in a distributed manner using processing resources of at least two of the multiple mobile robots.

5. The computerized system of claim 1, wherein the processor is a central processor located in one of the multiple mobile robots.

6. The computerized system of claim 1, wherein the processor is a central processor located in a controlling device communicating with the multiple mobile robots.

7. The computerized system of claim 1, further comprising a mission history memory for storing information concerning prior missions performed by the multiple mobile robots.

8. The computerized system of claim 1, further comprising a battery memory for storing information concerning the battery status the multiple mobile robots, wherein the processor determines whether or not a specific mobile robot of the multiple mobile robots is capable to perform the mission based on battery consumption estimated to be consumed during the mission for the specific mobile robot and the battery status stored in the battery memory.

9. The computerized system of claim 1, wherein the processor predicting additional missions to be performed by the multiple mobile robots during a time period overlapping with the mission based on prior missions' experience, wherein the processor selecting a first group of mobile robots of the multiple mobile robots to perform the additional missions, wherein the one or more mobile robots assigned to perform the mission are excluded from the first group of mobile robots.

10. The computerized system of claim 1, wherein the mission requires docking one or more mobile robots to a dock station, wherein the dock station is selected based on the location of the mission, and the processor verifying that the assigned mobile robot matches the selected dock station.

11. The computerized system of claim 10, further comprises a dock station memory coupled to the processor, said dock station memory storing properties of the multiple dock station, wherein a dock station is selected if properties of the dock station fit the mission.

12. The computerized system of claim 11, wherein the properties comprise network connectivity, materials contained in the dock station, processing capabilities of a dock station processor, size of the dock station and a combination thereof.

13. The computerized system of claim 12, wherein skills included in the set of skills comprise capturing images, cleaning, dispensing a material, carrying objects and a combination thereof.
